(19) United States
(12) Patent Application Publication
(10) Pub. No.: US 2022/0153618 A1
(43) Pub. Date: May 19, 2022

(54) METHOD FOR DETECTING ANOMALIES IN A WATER TREATMENT PLANT

(71) Applicant: L'Air Liquide Société Anonyme pour |'Etude et I'Exploitation des Procédés Georges Claude, Paris (FR)

(72) Inventors: Maric LEFRANC, Sceaux (FR); Thomas BOURGEOIS, Pairs (FR)

(21) Appl. No.: 17/441,633

(22) PCT Filed: Feb. 12, 2020
(86) PCT No.: PCT/EP2020/053650

§ 371 Date: Sep. 21, 2021

(30) Foreign Application Priority Data
Mar. 22, 2019 (EP) 19305357.6

(51) Int. Cl. C02F 3/00; G05B 23/02

(52) U.S. Cl. CPC C02F 3/006; G05B 23/0229; C02F 2303/14; C02F 2209/006; C02F 2209/008; C02F 2209/001

(57) ABSTRACT

A method for operating a water treatment plant comprises a phase of detecting anomalies in the operation of the plant, wherein the phase of detecting anomalies comprises an implementation of the following measures: providing data representative of the operating state of the plant, said data being provided by sensors installed at selected locations in the plant itself or on input or output pipes of the plant; where appropriate, providing additional data; and providing a system for acquiring and processing these data, this system being equipped with an algorithm for processing said data.

### CROSS REFERENCE TO RELATED APPLICATIONS

This application is a 371 of International Application No. PCT/EP2020/053650, filed Feb. 12, 2020, which claims priority to European Patent Application No. 19305357.6, filed Mar. 22, 2019, the entire contents of which are incorporated herein by reference.

### TECHNICAL FIELD

The present invention relates to the field of water treatment. More specifically, the present invention relates to the detection of anomalies in the operation of water treatment plants.

### BACKGROUND

By way of illustration, it is known that the detected anomalies may be the following:
The detection of breakages or failures of equipment or instruments.
The detection of an abnormal event, for example foaming.
The detection of operational changes (for example a change of operator).
The detection of a change in the nature or quantity of the effluents to be treated input into the process.
. . . etc.

It will be understood that this detection of anomalies may be beneficial for more than one reason:
On the one hand, it is difficult (if not impossible) for the on-site operator to monitor all the parameters of the plant in real time. An anomaly detection algorithm coupled with relevant measurements of various parameters of the plant would thus be particularly advantageous in order to make it possible to very quickly warn the operator of a problem within the plant, which problem could then be addressed at the earliest opportunity.
On the other hand, the providers of equipment and consumables are not usually present at the plant. Thus, such a tool could be extremely beneficial for alerting the providers in the event of a failure of one of the items of equipment (or in the event of a deviation from “normal” operation, indicative of a failure) or else for preventing failures in the event of overconsumption (or non-optimal use) of one of the consumables (for example a gas), and for allowing the providers to monitor, in real time, the probability of an anomaly of the plant (and to warn and help the on-site operator, if necessary remotely, for the purpose of process optimization).

The solutions presently proposed in this industry and in the literature do not advocate the use of sensors; they advocate the execution of laboratory analyses, which are performed at regular intervals, for example every week or every month, in order to be able to detect an anomaly. It is understood therefore that the frequency for detecting anomalies is low, and this method could miss a good number of major events occurring in the plant.

Another solution already discussed, and arguably slightly more relevant, consists in monitoring both laboratory analyses and also data provided by sensors that are installed on site and that provide measurements very regularly (for example every 15 minutes).

The problem in this case is that the operator generally has available a very large amount of data due to the numerous sensors, which have a great deal of variability, and monitoring all of these sensors independently of one another may cause many false alarms to be triggered, whilst missing the “true” anomalies.

By way of illustration, considered independently of the other measurements, a very substantial increase in the oxygen concentration may trigger an alarm because it is abnormal, however, this substantial increase may be explained by a very substantial decrease in the concentration of pollutants in the incoming effluent, which is not an anomaly in itself. In this case, a false alarm would be triggered.

Likewise, an increase in electrical current of the pump aerating the tanks may have two causes: an increase in the speed of the pump (if, for example, the gas flow rate is increased) or a failure of the motor. Measurement of the electrical current alone is therefore insufficient to provide a reliable alarm, whereas if it is coupled with other measurements, such as for example the oxygen demand of the aeration tank, the concentration of dissolved oxygen, or the oxygen flow rate, and by virtue of a suitable anomaly detection tool, a reliable alarm may be generated.

Lastly, it should be noted that some water treatment plants vary greatly in their operation, depending on the upstream process.

For example, mention may be made of water purification plants downstream of pharmaceutical or agrifood production sites: the nature of the effluent will change drastically from one production run to another, and therefore so too will the measured parameters. Coupling the parameters measured at the plant with a type of upstream production run then makes it possible to determine immediately whether the observed variations are attributable to an anomaly or to a change in the upstream production run.

False alarms are thus limited, and the number of correctly detected anomalies is maximized.

### SUMMARY

The object of the present invention is then to propose a new method for detecting anomalies arising in such an effluent processing installation, said method being based on an algorithm.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 shows the results of a probability calculation.

### DETAILED DESCRIPTION OF PREFERRED EMBODIMENTS

As will be seen in greater detail hereinafter, the method proposed here has a number of advantages:
The algorithm is able to process data of very varied nature, such as sensor measurements, state of a machine (in service/stopped), production run number, sensor calibration data, laboratory analysis files, each input data item being associated with a probability of occurrence, this allowing the analysis of complex scenarios.
The algorithm makes it possible to process a large amount of data. With the anticipated increase in the number of sensors and amount of available data, it is important to have a tool that makes it possible to aggregate all of this data, even if there is a very large amount of data. The amount and nature of the used input data is not limited.
A descriptive model is complex to implement; it requires development and validation steps for each purification plant configuration and possibly for each operating mode. The algorithm proposed here is, by contrast, a statistical tool; it is easily implemented and requires only one learning step on set-up. It may then be supplemented with new data over the life of the plant, for example with the addition of new sensors or new sources of information relating to the plant or its environment.
It allows a complex analysis in real time: by associating a high number of weak signals (i.e. slight variations in various parameters which do not trigger warnings when they are considered separately from one another) it is possible to reveal a bigger problem. A probability distribution links the various signals in order to analyze them from a global perspective and thus respect the dependence between certain events.
Regardless of the amount and nature of used data, the algorithm results in a single indicator which reflects the general state of the plant: a probability. If this probability is high, this means that the combination of data input into the algorithm is very probable, this meaning that the operation is normal. If the probability is low, this means that either a single data item or a combination of data items of the algorithm has/have a low probability of occurrence and this low probability of occurrence warns of an anomaly within the plant.

As explained above, the input data of the model may be of a varied nature. It may for example be a question of:
sensors: the sensors may be installed at various locations in the plant, for example on equipment (pumps, turbines, etc.), or even directly in the aeration tanks, or on inlet or outlet pipes of the plant, etc.
dates: the operation may be different depending on the seasons (stoppage of the plant in summer, colder average temperatures in winter, etc.), the day of the week (no production upstream in certain plants at the weekend), or even the time of day (less effluent received by the municipal purification plant at night-time), etc. For this reason, it may be beneficial to correlate the plant data with the time of day, day of the week, or season.
state of the upstream machine and of upstream production data: in these plants for purification of used industrial water, the nature of the effluents is dependent on the process upstream of the plant. For this reason, the state of the machine being used in the upstream process, or the reference of the production run under-way may explain the nature of the effluent, and may therefore be correlated with certain values measured in the purification plant.
weather data: climatic events (heavy rainfall, drought, extreme temperatures) may also be used to supplement the database by virtue of which the detection tool is able to function.

The following is a list of examples of sensors that may be used:
Dissolved oxygen sensor: this may be an electrochemical or optical sensor; however, an optical sensor will preferably be used. This sensor, placed in an aeration tank, makes it possible to measure the concentration of dissolved oxygen.

This measurement may be particularly relevant simultaneously with a strong aeration of the tank, because the rate of increase in the concentration of dissolved oxygen during the aeration (and of decrease on stoppage of the aeration) are each (coupled with the aeration flow rate) good indicators of correct operation of the aeration equipment on the one hand, and of the oxygen demand of the activated sludges in the aeration tank on the other hand.
Electrochemical probe, such as pH or redox probes; probes comprising 3 electrodes will preferably be used, in order to compensate for the impact of certain interfering ions, as well as probes equipped with temperature sensors in order to compensate for the impact of the temperature. The time of use of the probe, as well as the variation over time in the measurement, may also be monitored, because these are indicators of correct operation of the probe, and therefore of the reliability of the measurement.
Selective membrane probe. These electrochemical probes comprise a membrane that is permeable only for certain chemical species; they therefore make it possible to measure concentrations of ammonium, of nitrate, or other chemical species that it is sought to degrade in the plant. Similarly to the pH/redox probes, probes comprising 3 electrodes and a temperature compensation will be preferred.
Spectral probe: Increasing numbers of probes that make it possible to measure organic load, nitrogen load or amount of suspended material by spectrophotometry are available on the market. A number of types of probes may be used: measurement of the absorption at one or more wavelengths, measurement of the fluorescence peak over a relatively large wavelength range. In all cases, the optical measurement may be correlated with the concentration of organic or nitrogen pollution. Probes that make it possible to measure the absorption spectrum over an extended range, thus making it possible on the one hand to compensate for the effect of the turbidity and on the other hand to construct more robust correlations will be preferred. This probe will advantageously be placed upstream and/or downstream of the aeration tank.
Online analyzer: alternatively, the concentrations of various chemical species may be obtained by online analyzers. In this case, the analyzer is advantageously situated in proximity to the tank, and a sample is taken at regular intervals for analysis.
Turbidity: A probe making it possible to measure turbidity may be used, or any other measurement able to be correlated with turbidity, or with the concentration of solids in suspension (backscattered light, light scattered at 60°, absorbed light, etc.). This probe will possibly be placed upstream of the aeration tank, or downstream, or directly in the aeration tank.
Conductivity: Conductivity is a fairly reliable and easily measurable indicator of water quality. In some cases, it may be correlated with the chemical oxygen demand (COD—in municipal water, for example). It may be measured by a conductive or inductive method, or any other method that makes it possible to estimate conductivity. This probe may be placed in the pipes upstream or downstream of the plant, or directly in the aeration tank.
Gas flow rate: the flow rate of oxygen (or of air) injected into the aeration tank may be monitored. A flowmeter (preferably a thermal mass flowmeter) is placed upstream of the equipment used to inject gas into the tank.
Vibration sensor. Vibrations of the equipment for injecting gas into the water are measured. The sensor is preferably placed on the geared motor (or alternatively on the motor). The signal monitored may be selected from the vibration spectrum, or a deviation from a vibration spectrum generated during normal operation.
Current clamp. This clamp, placed around the electrical supply to the aeration equipment, makes it possible to measure the current of the motor. This clamp may be accompanied by a temperature measurement.
Water or sludge flow rate: Ultrasonic or electromagnetic flow meters may be used at various points of the plant: upstream for the incoming effluent flow, downstream for the outgoing treated water flow, during sludge recirculation, etc.

This list of sensors is of course only illustrative of the sensors that may be used and is in no way exhaustive.

As regards the algorithm proposed in accordance with the present invention, any sensors that make it possible to monitor a parameter of particular interest in the purification plant in question and that have not been mentioned above will possibly be added.

As described above, the present invention proposes to implement an algorithm for interpreting data, making it possible to calculate what is the probability of the sensors giving the value that they display. If this probability is high, it is considered that there are no anomalies; if this probability is low, the algorithm detects an anomaly.

More precisely:
in a training phase (i.e. phase of creation of an expert system): a probability distribution for all of the sensors is calculated;
in the phase of use of the algorithm: the values that are read by the sensors are inserted into the probability calculation algorithm. If this probability is low, this indicates that the sensors are delivering very different values from those that they delivered during the learning phase; the algorithm thus detects, or flags, an anomaly.

Mathematically, two examples of algorithms are presented below: A simplified version with independent Gaussian distributions and a more complex and more precise version with a multivariate Gaussian.

### Algorithm 1:

1. Training over the period of time t₁ to tₘ:
   a. Selection of input data xⱼ(t), j=1 . . . n, which could be indicative of anomalies. Ex: xⱼ may be all the measurements performed in the plant (for example by the examples of sensors listed above).
   b. Calculation of the parameters μ₁, . . . , μₙ, σ₁, . . . , σₙ with the following formulas:

$${μ}_{j} = \frac{1}{m} {\sum }_{{t}_{i} = {t}_{1}}^{{t}_{m}} {x}_{j} ( {t}_{i} )$$

$${σ}_{j}^{2} = \frac{1}{m} {\sum }_{{t}_{i} = {t}_{1}}^{{t}_{m}} {( {x}_{j} ( {t}_{i} ) - {μ}_{j} )}^{2}$$

where μⱼ=mean of the variable j over the training period, and σⱼ=the standard deviation of the variable j over the training period.
2. Use of the algorithm for the period of time t>tₘ:

Considering a new time step t, calculation of p(t):

$$p ( t ) = {\prod }_{j = 1}^{n} \vert \underline{} \vert p ( {x}_{j} ( t ) ; {μ}_{j} , {σ}_{j}^{2} ) = {\prod }_{j = 1}^{n} \vert \underline{} \vert \frac{1}{\sqrt{2 π} {σ}_{j}} exp exp ( - \frac{{( {x}_{j} ( t ) - {μ}_{j} )}^{2}}{2 {σ}_{j}^{2}} )$$

An anomaly is detected if: p(t)<ϵ.

### Numerical Example

2 input variables:
x₁, concentration of oxygen in the tank
x₂, concentration of pollutants at the inlet

Over a training period of 3 months, the following is calculated:

μ₁=2 g/m³

μ₂=100 g(Carbon)/m³

σ₁=0.3 g/m³

σ₂=5 g(Carbon)/m³

A minimum anomaly threshold is set to ϵ=10⁻⁴.

Then, over the period of use of the algorithm, the following new sensor values are observed:

x₁(t)=2.1 g/m³

x₂(t)=96 g/m³

The following probability density may then be calculated:

$$p ( t ) = {\prod }_{j = 1}^{n} \vert \underline{} \vert \frac{1}{\sqrt{2 π} {σ}_{j}} exp exp ( - \frac{{( {x}_{j} ( t ) - {μ}_{j} )}^{2}}{2 {σ}_{j}^{2}} ) = 0.072$$

Over this first time step, the probability is high; therefore, no anomaly is detected.

Over a second time step

$${x}_{1} ( t ) = 2.7 g \text{/} {m}^{3}$$

$${x}_{2} ( t ) = 85 g \text{/} {m}^{3}$$

$$p ( t ) = {\prod }_{j = 1}^{n} \vert \underline{} \vert \frac{1}{\sqrt{2 π} {σ}_{j}} exp exp ( - \frac{{( {x}_{j} ( t ) - {μ}_{j} )}^{2}}{2 {σ}_{j}^{2}} ) = 7.75 {10}^{- 5} < ϵ$$

Since this second probability is very low, it is indicative of an anomaly.

Since this second probability is very low, it is indicative of an anomaly.

### Algorithm 2:

1. Training over the period of time t₁ to tₘ:
   a. Selection of input data xⱼ(t), which could be indicative of anomalies. Ex: xⱼ may be all the measurements performed in the plant (for example by the examples of sensors listed above).
   b. Calculation of the parameters μ and Σ with the following formulas: (note: x, μ and Σ are multi-dimensional, in this second version)

$$μ = \frac{1}{m} {\sum }_{{t}_{i} = {t}_{1}}^{{t}_{m}} x ( {t}_{i} )$$

$$Σ = \frac{1}{m} {\sum }_{{t}_{i} = {t}_{1}}^{{t}_{m}} ( x ( {t}_{i} ) - μ ) {( x ( {t}_{i} ) - μ )}^{T}$$

2. Use of the algorithm for t>tₘ:

Considering a new time step t, calculation of p(t):

$$p ( t ) = \frac{1}{{( 2 π )}^{\frac{n}{2}} {\vert Σ \vert}^{\frac{1}{2}}} exp exp ( - \frac{1}{2} {( x ( t ) - μ )}^{T} {Σ}^{- 1} ( x ( t ) - μ ) )$$

An anomaly is detected if: p(t)<ϵ

### Numerical Example

The same example as above with the values of the second time step is now considered:

x₁(t)=2.7 g/m³

x₂(t)=85 g/m³

The following is thus calculated:

$$μ = [ 2 \frac{g}{{m}^{3}} , 100 \frac{g}{{m}^{3}} ]$$

$$Σ = [ [ 0.09 , - 0.2 ] , [ - 1 , 25 ] ]$$

The following probability density is then calculated:

$$p ( t ) = \frac{1}{{( 2 π )}^{\frac{n}{2}} {\vert Σ \vert}^{\frac{1}{2}}} exp exp ( - \frac{1}{2} {( x ( t ) - μ )}^{T} {Σ}^{- 1} ( x ( t ) - μ ) ) = 0.0014 > ϵ$$

The algorithm allows for the dependency of the variable x₁ in relation to the variable x₂. The fact of there being a high concentration of O₂ may be explained by the low concentration of pollutants at the inlet. Therefore, no anomalies are detected.

Below, an exemplary embodiment realized in the context of a water treatment plant in France and in which around twenty sensors from the following list were arranged, will be presented:
sensors of concentration of oxygen in the tanks
sensors of injected oxygen flow rate
sensors of carbon-containing pollution at the inlet of the tank (measurement of COD or “chemical oxygen demand”, here measured in the laboratory)
sensors of surface solids, likewise at the tank inlet (measurement of SM “suspended materials”, here measured in the laboratory)
measurements of flow rate of effluent at the plant inlet

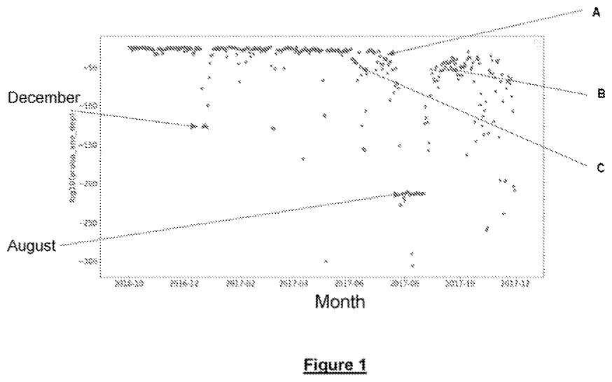

The graph annexed in FIG. 1 shows the results of a probability calculation. The month of the period in question is plotted on the abscissa, and the logarithm of the calculated (here with algorithm 2) probability density at each time is plotted on the ordinate. The logarithm makes it possible to “flatten the values” in order to better see the substantial drops in probability at certain times.

The algorithm (algorithm 2) is “trained” over a period of two months (November and December). The algorithm then provides the probability linked to the values measured by the sensors over a period of one year from December to December.

The algorithm shows very low probability values, which may be explained very easily, in the following periods:
holiday periods: end of December, month of August, various bank holidays (in the month of May for example);
a period of stoppage of the plant at the very beginning of March.

However, the algorithm also shows very low values in the following periods:
start of July and all of September-October. At these times, it would seem that foam formed in the plant on the site. The algorithm shows that it effectively detects an anomaly during this period.
already at the start of June, the algorithm shows much lower probability values than during the training period. These low probabilities may be explained by a change of operator of the plant.

The detection of the last two events is very beneficial both to the gas provider and also to the site user; this makes it possible for example to understand an excessive consumption of oxygen by the equipment. This could also be beneficial from the viewpoint of safeguarding the installations.

In summary, the following facts may be surmised from the FIGURE:
at A: foam was first detected at the start of July:
at B: a lot of foam was observed September-October;
at C: the fact that this phenomenon could have been anticipated as early as July, following a change of operator in the plant.

The present invention thus relates to a method for operating a water treatment plant, which comprises a phase of detecting anomalies in the operation of the plant, characterized in that the anomaly-detecting phase comprises the implementation of the following measures:
data representative of the operating state of the plant are provided, these data being provided by sensors installed at selected locations in the plant itself or on input or output pipes of the plant, and, where appropriate, additional data are also provided, these data being comprised in the group formed by:
   i) data regarding dates/periods during which the operation of the plant was being monitored;
   j) data representative of the state of the upstream machine producing the effluents to be treated in the plant;
   k) weather data characterizing the climatic conditions under which the operation of the plant was being monitored;
a system for acquiring and processing these data is provided, this system being equipped with an algorithm for processing these data capable of carrying out the following:
   a. carrying out a learning phase during which the system calculates the parameters of a probability distribution for all of the sensors and, where appropriate, said additional data;
   b. carrying out a phase of using the algorithm in which the system inserts values that are read in real time by the sensors into the algorithm, in order to calculate a probability density for all of the sensors and, depending on the result of this density, if this probability is low, to conclude that the sensors are delivering very different values from those that they delivered during the learning phase, and then to flag an anomaly.

In accordance with a preferred embodiment of the invention, the system for acquiring and processing data is also able to communicate in the following way:
it is able to communicate with a cloud/hosted IT system;
it is able to transmit aggregated data (by wire or wirelessly) to a server;
the server is programmed to receive the data, store them in databases, convert these data into a format suitable for viewing, and process said data according to recommendations;
the results of the algorithm, as well as the data necessary for the calculations of the algorithm, are thus available remotely on a digital medium, such as a tablet, a telephone, a computer.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

As used herein, “about” or “around” or “approximately” in the text or in a claim means ±10% of the value stated.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

All references identified herein are each hereby incorporated by reference into this application in their entireties, as well as for the specific information for which each is cited.

1. A method for operating a water treatment plant; comprising a phase of detecting anomalies in the operation of the plant, wherein the phase of detecting anomalies comprises an implementation of the following measures:
providing data representative of the operating state of the plant, said data being provided by sensors installed at selected locations in the plant itself or on input or output pipes of the plant,
where appropriate, providing additional data, said data are selected from the group comprising:
i) data regarding dates/periods during which the operation of the plant was being monitored;
j) data representative of the state of the upstream machine producing the effluents to be treated in the plant; and
k) weather data characterizing the climatic conditions under which the operation of the plant was being monitored;
providing a system for acquiring and processing these data, this system being equipped with an algorithm for processing said data capable of carrying out the following:
a) carrying out a learning phase during which the system calculates the parameters of a probability distribution for all of the sensors and, where appropriate, said additional data; and
b) carrying out a phase of using the algorithm, wherein the system inserts values that are read in real time by the sensors into the algorithm, in order to calculate a probability density for all of the sensors and, depending on the result of the probability density, if the probability is low, to conclude that the sensors are delivering very different values from those that the sensors delivered during the learning phase, and then to flag an anomaly.

2. The of claim 1, wherein the system for acquiring and processing is able:
to communicate with a cloud/hosted IT system; and
to transmit said data provided by the sensors, and, where appropriate, said additional data, as well as the results provided by the algorithm, to a remote server, the server being itself able to receive said data, store them in databases, convert said data into a format suitable for viewing, and process said data in accordance with recommendations, allowing remote access to said data and results on a digital medium to all authorized individuals.
